(19) United States
(12) Patent Application Publication
(10) Pub. No.: US 2011/0224377 A1
(43) Pub. Date: Sep. 15, 2011

(54) POLY(VINYL ESTER) BLOCK COPOLYMERS

(76) Inventors: Mahesh Kalyana Mahanthappa, Madison, WI (US); Corinne Elizabeth Lipscomb, Madison, WI (US)

(21) Appl. No.: 12/722,237

(22) Filed: Mar. 11, 2010

(51) Int. Cl. C08F 293/00; C08F 18/04

(52) U.S. Cl. 525/200; 525/228; 525/213; 525/217

(57) ABSTRACT

Poly(vinyl ester) block copolymers comprising blocks of two or more different vinyl ester repeating units. The vinyl ester repeating units may be

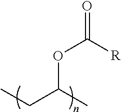

wherein R is H, C₁-C₂₂ straight or branched alkyl or alkylhalide, or phenyl or substituted phenyl, and n is 10 to 12,000. Methods of making poly(vinyl ester) block copolymers, including reversible-addition fragmentation chain transfer, organobismuthine-mediated living radical polymerization, and cobalt mediated radical polymerization. Chemically-degradable and biodegradable polymers comprising poly(vinyl ester) block copolymers.

### STATEMENT REGARDING FEDERALLY FUNDED RESEARCH

This invention was made with U.S. government support under grant number DMR-0748503 awarded by the National Science Foundation. The government has certain rights in the invention.

### BACKGROUND

Vinyl ester homopolymers, such as poly(vinyl acetate), are used in commodity applications as adhesives, paper coatings, chewing gum bases, and biomedical materials. By virtue of their economical production by palladium-catalyzed oxidative coupling of ethylene with carboxylic acids, or transesterification of carboxylic acids with vinyl acetate, a wide variety of vinyl ester monomers are available on commodity scales. Polymers derived from these monomers exhibit a variety of physical and chemical properties, however, many are both chemically degradable and biodegradable through ester side chain hydrolysis to yield carboxylic acids and poly(vinyl alcohol). The poly(vinyl alcohol), in turn, degrades by a variety of mechanisms to produce small molecules including acetaldehyde and acetic acid. Nonetheless, the all-carbon backbone of these polymers renders them thermally stable and amenable to melt processing for potentially broad applications.

### SUMMARY

In one embodiment, the invention provides a vinyl ester multiblock copolymer comprising three blocks of two different vinyl ester repeating units. The vinyl ester repeating units may be

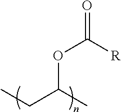

wherein R is H, C₁-C₂₂ straight or branched alkyl or alkylhalide, or phenyl or substituted phenyl, and n is 10 to 12,000. In some embodiments the vinyl ester repeating units are selected from vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate. The vinyl ester multiblock copolymer may comprise four blocks of two different vinyl ester repeating units, five blocks of two different vinyl ester repeating units, three blocks of three different vinyl ester repeating units, four blocks of three different vinyl ester repeating units, or five blocks of three different vinyl ester repeating units.

In another embodiment, the invention provides a vinyl ester diblock copolymer comprising repeating units selected from the group consisting of vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate. The vinyl ester diblock copolymers may additionally comprise repeating units of

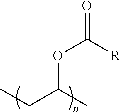

wherein R is H, C₁-C₂₂ straight or branched alkyl or alkylhalide, or phenyl or substituted phenyl, and n is 10 to 12,000.

In another embodiment, the invention provides a method of making a vinyl ester block copolymer comprising contacting a vinyl ester monomer with

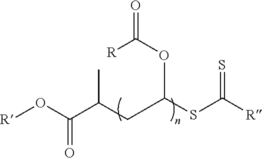

wherein R is H, C₁-C₂₂ straight or branched alkyl, or phenyl or substituted phenyl, R′ is C₁-C₆ branched or straight-chain alkyl, or phenyl or substituted phenyl, R″ is C₁-C₄ alkoxy, phenoxy or substituted phenoxy, or NR₂′″ wherein R′″ is phenyl or substituted phenyl [please verify], and n is 10 to 12,000, and forming a vinyl ester block copolymer. In some embodiments, R is phenyl, t-butyl, or methyl, R′ is ethyl, and R″ is ethoxy, N,N-diphenylamino, (4-methoxyphenyl)oxy, or 4-fluorophenoxy. The vinyl ester monomer may be selected from the group consisting of vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

In another embodiment, the invention provides a method of making a vinyl ester multiblock copolymer comprising contacting a vinyl ester monomer with

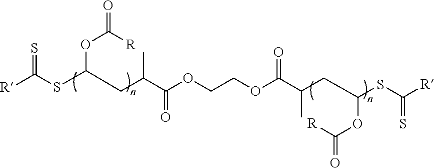

wherein R is H, C₁-C₂₂ straight or branched alkyl or alkylhalide, or phenyl or substituted phenyl, R′ is C₁-C₄ alkoxy, phenoxy or substituted phenoxy, or NR₂″ wherein R″ is phenyl or substituted phenyl [please verify], and n is 10 to 12,000, and forming a vinyl ester multiblock copolymer. In some embodiments, R is phenyl, t-butyl, or methyl, and R′ is ethoxy, N,N-diphenylamino, 4-methoxyphenyl)oxy, or 4-fluorophenoxy. The vinyl ester monomer may be selected from the group consisting of vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

In another embodiment, the invention provides a method of making a vinyl ester-block-vinyl benzoate copolymer comprising contacting vinyl ester monomers with cobalt(II) acetylacetonate, an organic peroxide, an inorganic peroxide, or an organic diazo compound, and a reducing agent to make a vinyl ester monomer mixture, heating the vinyl ester monomer mixture to make a cobalt end-capped vinyl ester polymer, cooling the cobalt end-capped vinyl ester polymer, contacting the cobalt-end capped vinyl ester polymer with vinyl benzoate monomer to make a cobalt end-capped vinyl ester polymer-vinyl benzoate monomer mixture, and heating the cobalt end-capped vinyl ester polymer-vinyl benzoate monomer mixture to make a cobalt end-capped vinyl ester-block-vinyl benzoate copolymer. The vinyl ester monomers may be selected from the group consisting of vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

In another embodiment, the invention provides a method of making a vinyl ester multiblock copolymer comprising contacting first vinyl ester monomers with cobalt(II) acetylacetonate, an organic peroxide, an inorganic peroxide, or an organic diazo compound, and a reducing agent to make a first vinyl ester monomer mixture, heating the first vinyl ester monomer mixture to make a cobalt end-capped first vinyl ester polymer, cooling the cobalt end-capped first vinyl ester polymer, contacting the cobalt end-capped first vinyl ester polymer with second vinyl ester monomers to make a cobalt end-capped first vinyl ester polymer-second vinyl ester monomer mixture, heating the cobalt end-capped first vinyl ester polymer-second vinyl ester monomer mixture to make a cobalt end-capped first vinyl ester-block-second vinyl ester copolymer, cooling the cobalt end-capped first vinyl ester-block-second vinyl ester copolymer, contacting the cobalt end-capped first vinyl ester-block-second vinyl ester copolymer with third vinyl ester monomers to make a cobalt end-capped first vinyl ester-block-second vinyl ester copolymer-third vinyl ester monomer mixture, and heating the cobalt end-capped first vinyl ester-block-second vinyl ester copolymer-third vinyl ester monomer mixture to make a vinyl ester multiblock copolymer. The first, second, and third vinyl ester monomers may be selected from the group consisting of vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate. In some embodiments, the first and third vinyl ester monomers may be the same.

In another embodiment, the invention provides a method of making a vinyl ester block copolymer comprising contacting first vinyl ester monomers with an organobismuthine and an organic peroxide, an inorganic peroxide, or an organic diazo compound to make a first vinyl ester monomer mixture, heating the first vinyl ester monomer mixture to make a bismuth end-capped first vinyl ester polymer, cooling the bismuth end-capped first vinyl ester polymer, contacting the bismuth end-capped first vinyl ester polymer with second vinyl ester monomers to make a bismuth end-capped first vinyl ester polymer-second vinyl ester monomer mixture, and heating the bismuth end-capped first vinyl ester polymer-second vinyl ester monomer mixture to make a first vinyl ester-block-second vinyl ester block copolymer. The first and second vinyl ester monomers may be selected from the group consisting of vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

In another embodiment, the invention provides a degradable polymer comprising a vinyl ester multiblock copolymer comprising three blocks of two different vinyl ester repeating units.

In another embodiment, the invention provides a degradable polymer comprising a vinyl ester diblock copolymer comprising repeating units selected from the group consisting of vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

Other aspects of the invention will become apparent by consideration of the detailed description and accompanying drawings.

### BRIEF DESCRIPTION OF THE DRAWINGS

FIG. 1 compares size exclusion chromatograms (refractive index signal versus elution time) of a PVPv-macro RAFT agent and a PVPv-b-PVAc block copolymer establishing a shift in the elution time consistent with the formation of a higher molecular weight block copolymer.

FIG. 2 shows a two-dimensional SAXS pattern of a PVPv-b-PVAc block copolymer. The pattern is indicative of a microphase separated block copolymer having a hexagonal morphology.

FIG. 3 compares size exclusion chromatograms (refractive index versus elution time) of a PVBz-macro RAFT agent and a PVBz-b-PVAc block copolymer, establishing a shift in the elution time consistent with the formation of a higher molecular weight block copolymer.

FIG. 4 shows a two-dimensional SAXS pattern of a PVPv-b-PVAc block copolymer. The single broad peak in the absence of higher order scattering maxima is the signature of correlation hole scattering indicative of a melt disordered block copolymer.

FIG. 5 shows a two-dimensional SAXS pattern of a PVBz-b-PVPv block copolymer. The pattern is indicative of a microphase separated block copolymer having a lamellar morphology.

### DETAILED DESCRIPTION

The invention encompasses vinyl ester multiblock copolymers comprising at least three blocks of two different vinyl ester repeating units as well as numerous vinyl ester diblock copolymers. The invention additionally encompasses Reversible-Addition Fragmentation chain Transfer (RAFT), organobismuthine-mediated living radical polymerization, and cobalt-mediated radical polymerization (CMRP) methods of making poly(vinyl ester) multiblock and diblock copolymers.

Block copolymers comprise two or more different blocks of repeating units. As used herein, “diblock” refers to block copolymers that have only two blocks of repeating vinyl ester units (A-b-B). “Multiblock” refers to block copolymers that have more than two blocks of repeating vinyl ester units. For example multiblock copolymers may include three blocks of two different repeating vinyl ester units (A-b-B-b-A), or three blocks of three different repeating vinyl ester units (A-b-B-b-C). Multiblock copolymers may include four blocks of two different repeating vinyl ester units (A-b-B-b-A-b-B), four blocks of three different repeating vinyl ester units (A-b-B-b-C-b-A or A-b-B-b-C-b-B), or four blocks of four different repeating vinyl ester units (A-b-B-b-C-b-D). Multiblock copolymers may include five, or six, or seven, or eight, or nine, or ten, or eleven, or twelve, etc., blocks of repeating vinyl ester units. Multiblock copolymers may include repeating units which are not vinyl esters as well. Multiblock copolymers may be linear, branched, or star-shaped.

In general, the multiblock copolymers of the invention contain repeating units of

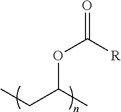

wherein R is H, C₁-C₂₂ straight or branched alkyl or alkylhalide, or phenyl or substituted phenyl, and n is 10 to 12,000. The number of repeating units, n, (also the “chain length”) may be greater than 100, greater than 1000, or greater than 10,000. As used herein, the term “alkyl” refers to branched and unbranched, saturated or unsaturated, substituted or unsubstituted alkyl groups, such as alkenyl and alkynyl groups. “Alkylhalide” refers to the partial or total halogenated equivalents of the alkyl structures, i.e., fluoro, chloro, bromo, or iodo. Additionally, as used herein, “substituted phenyl” refers to phenyl moieties substituted with C₁-C₆ alkyl, alkoxy, amino, dialkyl amino, or halo (i.e., fluoro, chloro, bromo, or iodo) at any carbon of the phenyl ring. In some embodiments, the vinyl ester repeating units may be vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, or vinyl 2-chloropropionate, or some combination thereof.

A “repeating unit” refers, generally, to a repeating molecular structure in a polymer, typically resulting from the polymerization of a monomer. As used herein, “monomer” typically refers to a separate molecular precursor to a polymer, e.g., vinyl acetate monomer, CH₃COOCH═CH₂. However, in some instances “monomers” may be used colloquially to refer to the repeating structure inside a polymer. Multiblock copolymers may include repeating units which are not vinyl esters in addition to vinyl esters. Such non-vinyl ester repeating units include, but need not be limited to, styrenes and substituted styrenes, alkyl-, phenyl-, and substituted phenyl-acrylates; alkyl-, phenyl-, and substituted phenyl-methacrylates; alkyl-, phenyl-, and substituted phenyl-acrylamides; and alkyl-, phenyl-, and substituted phenyl-methacrylamides.

The diblock copolymers of the invention may contain repeating units of

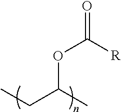

wherein R is H, C₁-C₂₂ straight or branched alkyl or alkylhalide, or phenyl or substituted phenyl, and n is 10 to 12,000, however diblock copolymers of the invention do not contain both a block of vinyl acetate and a block of vinyl pivalate. The number of repeating units, n, may be greater than 100, greater than 1000, or greater than 10,000. For example, diblock copolymers of the invention may contain any two blocks selected from vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

Typically, poly(vinyl ester) block copolymers of the invention have low polydispersity indices, indicating that the blocks are relatively consistent in chain length. (Polydispersity is defined as the ratio of the weight average molecular weight (M_{w}) divided by the number average molecular weight (Mₙ).) Poly(vinyl ester) block copolymers of the invention have polydispersity indices greater than about 1.0, typically greater than about 1.2, sometimes greater than about 1.4. Poly(vinyl ester) block copolymers of the invention may have polydispersity indexes less than about 2, typically less than about 1.9, sometimes less than about 1.5.

Poly(vinyl ester) block copolymers of the invention may find a wide variety of applications due to their chemical degradability and biodegradability. In general, homopolymers of vinyl esters are known to degrade chemically and biologically through ester side chain hydrolysis to yield carboxylic acids and poly(vinyl alcohol). The poly(vinyl alcohol), in turn, degrades by a variety of mechanisms to produce small molecules including acetaldehyde and acetic acid, which are incorporated into the environment. Poly(vinyl ester) block copolymers described herein are expected to chemically degrade and to biodegrade via similar mechanisms.

The ability to engineer specific diblock and multiblock copolymers will allow engineers and materials scientists the flexibility to choose specific nanoscale morphologies in order to control the bulk properties of poly(vinyl ester) copolymers and plastics incorporating the copolymers. Such copolymers may possess unique anisotropies that are not present in homopolymers or random copolymers produced from the same monomers. For example, block copolymers may have higher tensile strengths when compared to their homopolymer equivalents, or they may have superior “memory” once deformed, or they may self-heal. Additionally, poly(vinyl ester) block copolymers of the invention are melt stable, allowing them to be processed and utilized with conventional plastic engineering technology, including, but not limited to, injection molding, blow molding, casting, solvent casting, melt extrusion, melt spinning, and melt-drawing.

Specifically, poly(vinyl ester) block copolymers of the invention may find use in packaging applications, where either their chemical degradability or biodegradability will accelerate the breakdown of the packaging after the product has been used by a consumer. As such, poly(vinyl ester) block copolymers of the invention may be incorporated in food and beverage containers and packaging, toys, household goods, plastic bags, and shipping and storage containers.

Poly(vinyl ester) block copolymers of the invention may also lead to the development of new polymeric materials and polymer surfactants for biomedical applications. Such polymeric materials may be used for tissue/cell culture substrates, medical devices, surgical sutures, and drug delivery systems, among other applications. Other uses of the poly(vinyl ester) block copolymers of the invention will be evident to those of skill in the relevant art.

Diblock and multiblock poly(vinyl ester) block copolymers may be formed using Reversible Addition-Fragmentation Chain Transfer Polymerization (RAFT), a controlled polymerization technique in which monomers are polymerized to form blocks of repeating units with relatively narrow polydispersities. One method of Reversible Addition-Fragmentation Chain Transfer Polymerization, suitable for the formation of homopolymers of vinyl monomers, is disclosed in U.S. Pat. No. 6,747,111, incorporated herein by reference in its entirety. A method of forming diblock copolymers of vinyl esters, such as vinyl acetate, vinyl pivalate, and vinyl benzoate is disclosed in Lipscomb et al. “Poly(vinyl ester) block copolymers synthesized by Reversible Addition-Fragmentation Chain Transfer Polymerizations,” Macromolecules (2009), vol. 42, 4571-4579, incorporated herein by reference in its entirety.

Generally, poly(vinyl ester) diblock copolymers of the invention can be formed by contacting a vinyl ester monomer with a macro-RAFT agent of the structure

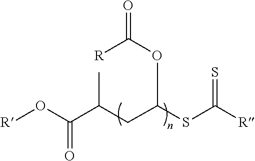

wherein R is H, C₁-C₂₂ straight or branched alkyl or alkylhalide, or phenyl or substituted phenyl, R′ is C₁-C₆ branched or straight-chain alkane, R″ is C₁-C₄ alkoxy, phenoxy or substituted phenoxy, or NR₂′″ wherein R′″ is phenyl or substituted phenyl, and n is 10 to 12,000. The first block of the diblock copolymer becomes a portion of the macro RAFT agent, and the second block is formed via controlled chain extension RAFT polymerization. Monomers suitable for use in the formation of poly(vinyl ester) diblock copolymers include any vinyl ester monomer of the structure

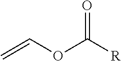

wherein R is H, C₁-C₂₂ straight or branched alkyl or alkylhalide, or phenyl or substituted phenyl. Monomers suitable for use in the formation of poly(vinyl ester) diblock copolymers include, but need not be limited to, vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

For example, a PVAc-b-PVPv diblock copolymer can be formed with the below synthesis, as described in greater detail in EXAMPLE 1.

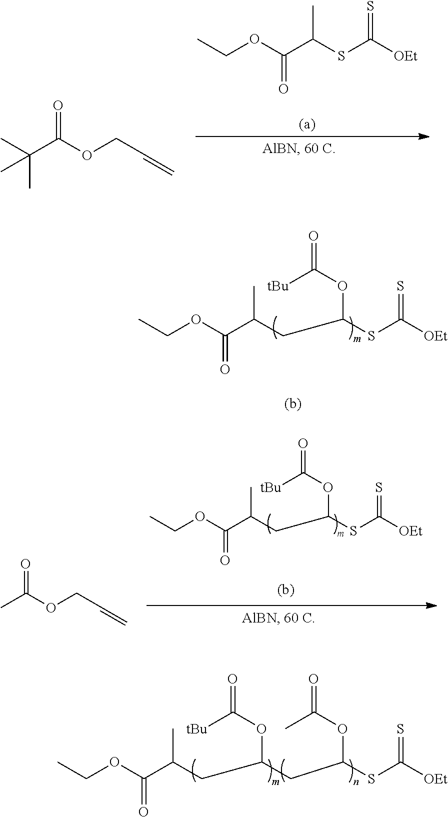

Additionally, the methods of the invention may be used to create multiblock copolymers using Reversible Addition-Fragmentation Chain Transfer Polymerizations. In one embodiment, a controlled free radical polymerization with vinyl ester monomers forms a macro-RAFT agent of the structure

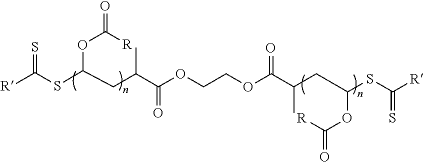

wherein R is H, C₁-C₂₂ straight or branched alkyl or alkylhalide, or phenyl or substituted phenyl, R′ is C₁-C₄ alkoxy, phenoxy or substituted phenoxy, or NR₂″ wherein R″ is phenyl or substituted phenyl, and n is 10 to 12,000. The macro-RAFT agent (above) may, in turn, be used to produce multiblock copolymers. Using the macro-RAFT agent above, an A-b-B-b-A type multiblock copolymer results when the macro-RAFT agent is contacted with a vinyl ester monomer. Vinyl ester monomers suitable for use in the formation of poly(vinyl ester) multiblock copolymers include any vinyl ester monomer of the structure

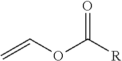

wherein R is H, C₁-C₂₂ straight or branched alkyl or alkylhalide, or phenyl or substituted phenyl. Monomers suitable for use in the formation of poly(vinyl ester) multiblock copolymers include, but need not be limited to, vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

In other embodiments, a controlled polymerization with vinyl ester monomers from a macro-RAFT agent of the structure

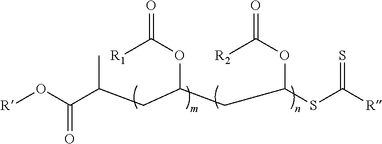

wherein R₁ and R₂ are independently H, C₁-C₂₂ straight or branched alkyl or alkylhalide, or phenyl or substituted phenyl, R′ is C₁-C₆ branched or straight-chain alkane, R″ is C₁-C₄ alkoxy, phenoxy or substituted phenoxy, or NR₂′″ wherein R′″ is phenyl or substituted phenyl, and m and n are independently 10 to 12,000, may be used to produce multiblock copolymers. In these embodiments, when the macro-RAFT agent is contacted with a vinyl ester monomer, an A-b-B-b-C type multiblock copolymer results. Vinyl ester monomers suitable for use in the formation of poly(vinyl ester) multiblock copolymers include any vinyl ester monomer of the structure

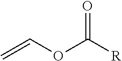

wherein R is H, C₁-C₂₂ straight or branched alkyl or alkylhalide, or phenyl or substituted phenyl. Monomers suitable for use in the formation of poly(vinyl ester) multiblock copolymers include, but need not be limited to, vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

Poly(vinyl ester) diblock copolymers of the invention may also be formed via cobalt-mediated radical polymerization (CMRP), whereby vinyl esters are polymerized in the presence of cobalt(II) acetylacetonate and an organic peroxide, an inorganic peroxide, or an organic diazo compound and a reducing agent. Generally, a solution of a first vinyl ester monomer is heated in the presence of cobalt(II) acetylacetonate, an initiator, and a reducing agent for some time to polymerize the first monomer, resulting in a cobalt end-capped first homopolymer block. The temperature of the polymerization reaction is greater than −10° C., typically greater than 10° C., more typically greater than 20° C. The time of polymerization is less than 24 hours, typically less than 12 hours, more typically less than 8 hours. The chain length of the block will generally be greater 1) at higher reaction temperatures and 2) at longer reaction times. Once the chain length of the first block has reached a sufficient length, the polymerization can be interrupted by cooling, and excess monomer can be removed from the solution to produce a cobalt end-capped first poly(vinyl ester) polymer. A second vinyl ester block may be added to the first vinyl ester block by mixing the first poly(vinyl ester) polymer with a second monomer, without introducing additional cobalt(II) acetylacetonate, additional initiator, nor additional reducing agent, and subsequently increasing the temperature to cause the second monomer to polymerize with the first poly(vinyl ester) polymer, thereby producing a cobalt end-capped A-b-B type diblock copolymer.

The fundamental mechanism of cobalt-mediated radical polymerization is described in greater detail in Debuigne, et al. “Overview of cobalt-mediated radical polymerization: Roots, state of the art and future prospects,” Progress in Polymer Science (2009) vol. 34, 211-239 incorporated herein by reference in its entirety. Initiators suitable for use with the cobalt-mediated radical polymerization methods of the invention include organic peroxide, inorganic peroxide, and organic diazo compounds. Such initiators include, but are not limited to, azobis(isobutyronitrile) (AIBN), LUPEROX™, 2,2′-azobis(4-methoxy-2,4-dimethyl valeronitrile), 1,1′-azobis(cyclohexane-1-carbonitrile), and 2,2′-azobis(2,4-dimethyl valeronitrile). Vinyl ester monomers suitable for use in the formation of poly(vinyl ester) diblock copolymers with CMRP include any vinyl ester monomer of the structure

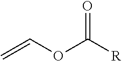

wherein R is H, C₁-C₂₂ straight or branched alkyl or alkylhalide, or phenyl or substituted phenyl. Suitable monomers may include, but need not be limited to, vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

Poly(vinyl ester) multiblock copolymers of the invention may also be formed with CMRP by polymerizing the same or different vinyl esters with diblock copolymers, formed above, in the presence of cobalt(II) acetylacetonate and an organic peroxide, an inorganic peroxide, or an organic diazo compound, and a reducing agent. Thus, it is possible to form A-b-B-b-A multiblock copolymers as well as A-b-B-b-C multiblock copolymers. The method may be generally extended to create multiblock copolymers having four, five, six, seven, eight, etc., blocks of vinyl esters. As for the diblock copolymers, vinyl ester monomers suitable for use in the formation of poly(vinyl ester) multiblock copolymers with CMRP include any vinyl ester monomer of the structure

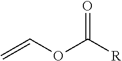

wherein R is H, C₁-C₂₂ straight or branched alkyl or alkylhalide, or phenyl or substituted phenyl. Suitable monomers may include, but need not be limited to, vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

In another embodiment of the invention, poly(vinyl ester) diblock copolymers may be formed via organobismuthine-mediated living radical polymerization (BIRP), whereby vinyl esters are polymerized at approximately 100° C. in the presence of organobismuthine chain transfer agents such as

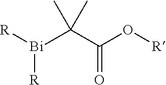

wherein R is C₁-C₂₂ straight or branched alkyl, and R′=C₁-C₂₂ straight or branched alkyl, phenyl or substituted phenyl, and, an organic peroxide, an inorganic peroxide, or an organic diazo compound, to produce a vinyl ester block. Upon cooling this reaction, the resultant bismuth end-capped vinyl ester homopolymer may be isolated and subsequently used as a organobismuthine macromolecular chain transfer agent of the form

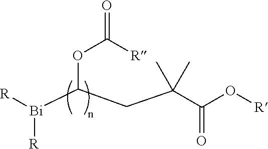

wherein R is C₁-C₂₂ straight or branched alkyl, and R′=C₁-C₂₂ straight or branched alkyl, phenyl or substituted phenyl, R″ is H, C₁-C₂₂ straight or branched alkyl or alkylhalide, or phenyl or substituted phenyl, and n is 10 to 12,000. Polymerization of a vinyl ester monomer with the macro organobismuthine chain transfer agent can then be initiated at elevated temperature to form a poly(vinyl ester) diblock copolymer. In some embodiments, polymerization may be initiated with an organic peroxide, an inorganic peroxide, or an organic diazo compound. By stopping the chain extension block copolymerization to form a diblock macro organobismuthine chain transfer agent, and subsequently contacting the macro organobismuthine chain transfer agent with a third vinyl ester monomer, multiblock poly(vinyl ester) copolymers may be formed of the type A-b-B-b-A, and A-b-B-b-C, etc. Vinyl ester monomers suitable for use in the formation of poly(vinyl ester) multiblock copolymers with organobismuthine-mediated living radical polymerization include any vinyl ester monomer of the structure

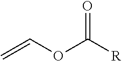

wherein R is H, C₁-C₂₂ straight or branched alkyl or alkylhalide, or phenyl or substituted phenyl. Suitable monomers may include, but need not be limited to, vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

It is to be understood that the invention is not limited in its application to the details of construction and the arrangement of components set forth in the following description. The invention is capable of other embodiments and of being practiced or of being carried out in various ways. Also it is to be understood that the phraseology and terminology used herein is for the purpose of description and should not be regarded as limiting.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any nonclaimed element as essential to the practice of the invention.

It also is understood that any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

Further, no admission is made that any reference, including any patent or patent document, cited in this specification constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinency of any of the documents cited herein.

### EXAMPLES

### Example 1

### Synthesis of PVAc-b-PVPv Copolymer with Reversible Addition-Fragmentation Chain Transfer Polymerization

Following Scheme 1, PVAc-b-PVPv diblock copolymers were synthesized using Reversible Addition-Fragmentation Chain Transfer Polymerization (RAFT):

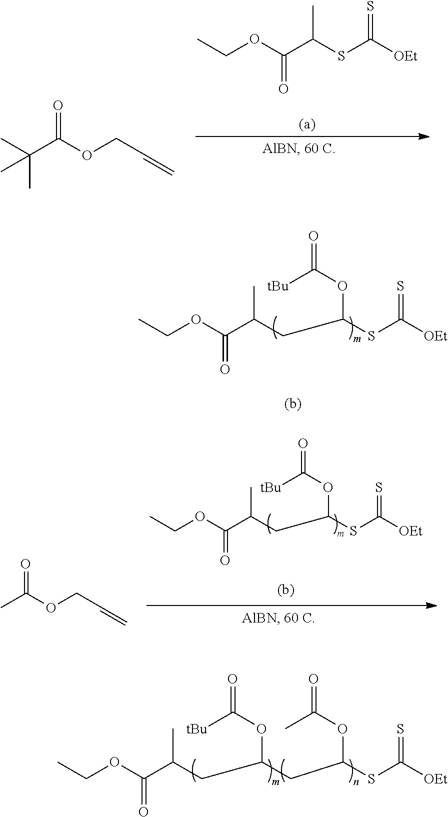

Synthesis of Ethyl 2-(ethoxycarbonothioylthio)propanoate (a): Ethyl 2-bromopropionate (7.15 g, 0.04 mol) (Sigma-Aldrich, St. Louis, Mo.) and potassium O-ethyl xanthogenate (8.87 g, 0.06 mol) (Sigma-Aldrich) were combined with 150 mL of ethanol in a 250 mL round bottom flask equipped with a stir bar and a septum. The reaction was stirred overnight at room temperature. After stirring, the reaction was gravity filtered to remove the KBr byproduct and excess xanthogenate. After filtration, ethanol was removed by rotary evaporation to yield a yellow oil. The yellow oil was purified by passage through a plug of activated Brockman Type I basic alumina (Sigma-Aldrich) using diethyl ether (Sigma-Aldrich) as the eluent. After passage through the basic alumina, the ether solution was rotary evaporated to yield a clear yellow liquid (5.64 g, 64.3% yield). ¹H NMR of the purified product (Bruker AC+300, CDCl₃, 22° C.) showed peaks at: δ (ppm) 4.63 (q, 2H), 4.39 (q, 1H), 4.20 (q, 2H), 1.56 (d, 3H), 1.41 (t, 3H), 1.27 (t, 3H).

Synthesis of PVPv-RAFT macro RAFT agent (b): Ethyl 2-(ethoxycarbonothioylthio)propanoate (46.1 mg, 0.23 mmol) (synthesized above) and 2,2′-Azobis(isobutyronitrile) (AIBN, Sigma-Aldrich) (0.023 mmol, 80 μL of 0.29 M solution in benzene) were dissolved in vinyl pivalate (VPv, 21.0 mL, 189.2 mmol) (Sigma-Aldrich), which had been distilled at ambient pressure from calcium hydride immediately prior to use. This solution was degassed by three freeze-pump-thaw, and sealed under vacuum. Reaction flask was immersed in a 60° C. oil bath to initiate the polymerization. After 120 minutes, the reaction flask was removed from the oil bath and cooled under running water to stop the polymerization. The PVPv-RAFT macro RAFT agent (structure (b) in Scheme 1) was then isolated by removal of the excess monomer under vacuum. In order to remove any traces of VPv monomer from the PVPv-RAFT macro RAFT agent, the solids were dissolved in benzene (Sigma-Aldrich) and freeze-dried in vacuum at room temperature.

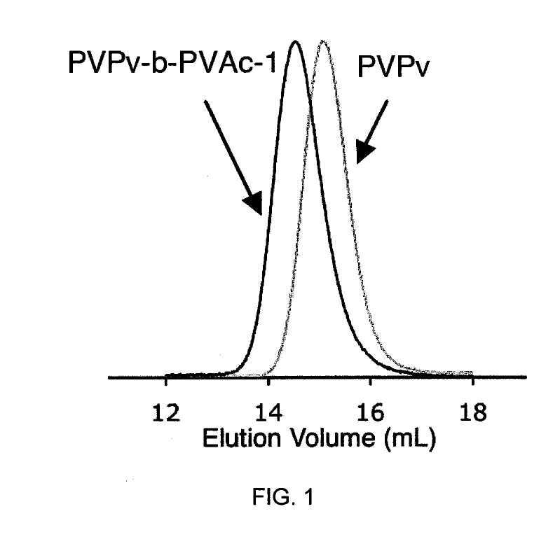

The PVPv-RAFT macro RAFT agent was characterized using size exclusion chromatography (SEC) (Viscotek GPCMax System equipped with two Polymer Labs Resipore columns (250 mm×4.6 mm), and four Viscotek detectors including a differential refractometer, two angle-light scattering module (7° and 90°), a four-capillary differential viscometer, and UV/Vis detector, Malvern Instruments, Ltd., Malvern, England). Tetrahydrofuran (THF) was used as the mobile phase at 30° C. with a flow rate of 1.0 mL/min. To enable absolute molecular weight determination using light scattering detection, the refractive index increment (dn/dc) for poly(vinyl pivalate) was determined by subjecting the single polymer sample to SEC analysis at several different concentrations and measuring the refractive index response at the peak molecular weight. The refractive index increment was then calculated as the slope of the linear fit of the detector response versus concentration curve assuming that the refractive index of THF at 30° C. is n_{THF}=1.406. At 30° C. in THF, the refractive index increments for poly(vinyl pivalate) was do/dc=0.076 L/g. An exemplary SEC trace of the PVPv-RAFT macro RAFT agent can be seen in FIG. 1. For this sample, Mₙ=14.8 kg/mol and M_{w}/Mₙ=1.28 (against PS Standards in THF) implying 22.5% monomer conversion in the polymerization reaction.

Synthesis of PVPv-b-PVAc copolymer. PVPv-RAFT macro RAFT agent (0.5 g, 0.034 mmol) (synthesized above) was dissolved in vinyl acetate (VAc) (4.8 mL, 52.1 mmol) (Sigma-Aldrich), which had been distilled at ambient pressure from calcium hydride (Sigma-Aldrich) immediately prior to use. The resulting molar ratio of PVPv-RAFT macro RAFT agent to vinyl acetate monomer was approximately 1 to 2026. Residual AIBN, present along with the PVPv-RAFT macro RAFT agent, was used as the sole source of free radicals to initiate the polymerization. The reaction solution was degassed by three freeze-pump-thaw cycles, sealed under vacuum, and heated to 60° C. After 3.5 hrs the reaction was removed from the heating bath. To terminate the polymerization the reaction was both cooled under running water and exposed to air. Excess vinyl acetate monomer was then removed by rotary evaporation. The resulting solid polymer was dissolved in benzene (Sigma-Aldrich) and freeze-dried in vacuo. The number-average molecular weight of the resultant PVPv-b-PVAc copolymer was Mₙ=24.8 kg/mol (based on 50.4 mol % VAc composition from ¹H NMR integrations of the acetate methyl group and the pivalate tert-butyl group and Mₙ of the PVPv-RAFT macro RAFT agent). The polydispersity of the resultant PVPv-b-PVAc copolymer was M_{w}/Mₙ=1.28 (against polystyrene standards in THF at 30° C.).

As a further verification of the formation of a PVPv-b-PVAc copolymer, the PVPv-b-PVAc and PVPv-RAFT macro RAFT agent were sequentially analyzed using size exclusion chromatography (SEC) under the conditions described above. Prior to running the samples, a conventional poly(styrene) calibration curve was constructed based on 10 narrow molecular weight distribution polystyrene standards with Mₙ=580-377400 Da (Polymer Labs, Amherst, Mass.) in order to estimate the polydispersity index of the block copolymers. An exemplary SEC trace comparing the unimodal PVPv-b-PVAc copolymer to the unimodal PVPv-RAFT macro RAFT agent can be seen in FIG. 1.

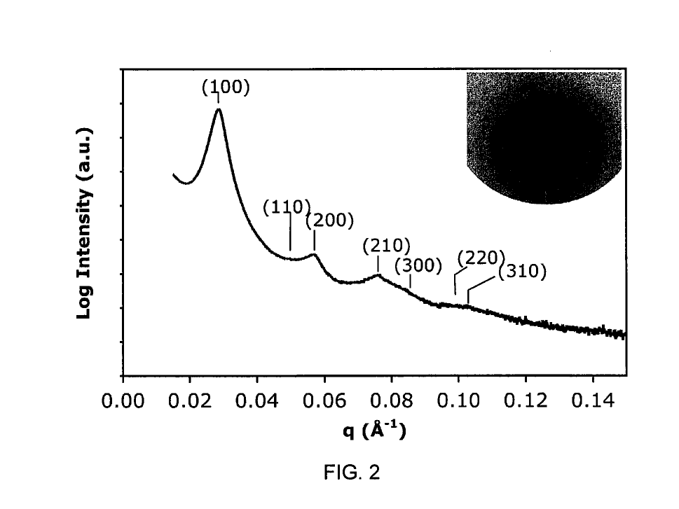

Microphase separation. The morphology of the resultant PVPv-b-PVAc copolymer was determined by taking small-angle X-ray scattering (SAXS) measurements of the PVPv-b-PVAc copolymer at the 5-IDD-beamline of the DuPont-Northwestern-DOW Collaborative Access Team Synchrotron Research Center at the Advanced Photon Source (Argonne National Labs, Argonne, Ill.). The scattering measurements were done with a beam energy of 16 keV (λ=0.7293 Å⁻¹) with the copolymer sample located 8.002 m from a 133 mm diameter active area X-ray CCD detector with 1048×1048 pixel resolution (MAR-CCD, Rayonix, LLC, Evanston, Ill.). SAXS measurements of the PVPv-b-PVAc copolymer sample were taken in a temperature-controlled stage (Thermatica Thermal Analysis System DSC600, Linkam Scientific Instruments, Surrey, UK). The temperature was allowed to equilibrate for 5 minutes before each data collection (typical exposure times ˜2 s). A SAXS measurement of the PVPv-b-PVAc copolymer at 160° C. is shown in FIG. 2. Starting from the raw CCD image, an azimuthally-integrated intensity profile is generated as a function of the magnitude of the scattering wavevector q (Å⁻¹). The various peaks in FIG. 2 are labelled to indicate the expected positions for reflections associated with a hexagonal morphology with q*=0.0291 Å⁻¹.

Using the methods above, a second PVPv-b-PVAc copolymer, was also synthesized using a ratio of 1 to 2749 of PVPv-RAFT macro RAFT agent to vinyl acetate monomer. This copolymer had a number-average molecular weight of Mₙ=23.7 kDa (based on 50.4 mol % VAc composition from ¹H NMR integrations of the acetate methyl group and the pivalate tert-butyl group). The polydispersity of the resultant second PVPv-b-PVAc copolymer was M_{w}/Mₙ=1.43 (against polystyrene standards in THF at 30° C.). SAXS analysis showed that this second PVPv-b-PVAc copolymer also microphase separated into a hexagonal morphology.

### Example 2

### Synthesis of PVAc-b-PVBz Copolymer with Reversible Addition-Fragmentation Chain Transfer Polymerization

Synthesis of PVAc-RAFT macro RAFT agent: Analogous to the protocol described in Example 1, methyl (Methoxycarbonothioyl)sulfanyl Acetate (41.6 mg, 0.21 mmol), synthesized according to a literature procedure (Stenzel et. al., Macromolecular Chemistry and Physics (2003), vol. 204, p. 1160, incorporated herein by reference in its entirety) and 2,2′-azobis(isobutyronitrile) (AIBN, Sigma-Aldrich) (4.4 mg, 0.03 mmol) were dissolved in 10.2 mL (126.9 mmol) of vinyl acetate (VAc) (Sigma-Aldrich), which had been stirred over basic alumina for 30 minutes and filtered immediately prior to use. This solution was degassed by three freeze-pump-thaw cycles, and sealed under vacuum. The was heated in a 60° C. oil bath to start the polymerization. After 2.9 hours, the reaction was removed from the oil bath, and cooled under running water to terminate the polymerization. The resulting PVAc-RAFT macro RAFT agent was then isolated by precipitation in 400 mL of stirred hexanes (Sigma-Aldrich) followed by vacuum filtration from cold methanol. In order to remove any traces of VAc monomer from the PVAc-RAFT macro RAFT agent, the solids were dissolved in benzene (Sigma-Aldrich) and freeze-dried in vacuum at room temperature. Size exclusion chromatography analysis was conducted on this sample using a poly(styrene) conventional calibration curve was constructed based on 10 narrow molecular weight distribution polystyrene standards with Mₙ=580-377400 Da (Polymer Labs, Amherst, Mass.), which was then subjected to Mark-Houwink conversion to generate an equivalent calibration curve for poly(vinyl acetate) homopolymers. This analysis showed that Mₙ=5.0 kg/mol and M_{w}/Mₙ=1.25 (against polystyrene standards in THF).

Synthesis of PVAc-b-PVBz copolymer: PVAc-RAFT macro RAFT agent (0.50 g, 0.10 mmol) (synthesized above) and AIBN (1.1 mg, 0.01 mmol) were dissolved in vinyl benzoate (VBz) (5.7 mL, 35.8 mmol) (Sigma-Aldrich), which had been stirred over basic alumina for 30 minutes and filtered immediately prior to use. The solution was degassed by three freeze-pump-thaw cycles sealed under vacuum, and heated to 80° C. After 10 hours, the reaction flask was removed from the heating bath. To terminate the polymerization, the reaction was both cooled under running water and exposed to air. The reaction solution was precipitated into 400 mL of stirred hexanes twice to remove residual vinyl benzoate monomer. The resulting polymer was then freeze dried from benzene in vacuum at 22° C. The number-average molecular weight of the resultant PVAc-b-PVBz copolymer was Mₙ=24.9 kDa (based on integration of the methine signals in the ¹H NMR spectrum associated with the homopolymer blocks). The polydispersity of the resultant PVAc-b-PVBz copolymer was M_{w}/Mₙ=1.33 (against polystyrene standards in THF at 30° C.).

Similar to Example 1, the resultant PVAc-RAFT macro RAFT agent and the PVAc-b-PVBz copolymer were sequentially analyzed using size exclusion chromatography (SEC) (Viscotek GPCMax System, described above). Tetrahydrofuran (THF) was used as the mobile phase at 30° C. with a flow rate of 1.0 mL/min. This analysis shows that both polymers are unimodal and that the copolymer molecular weight is higher than that of the macro RAFT agent as evidenced from the decreased elution volume.

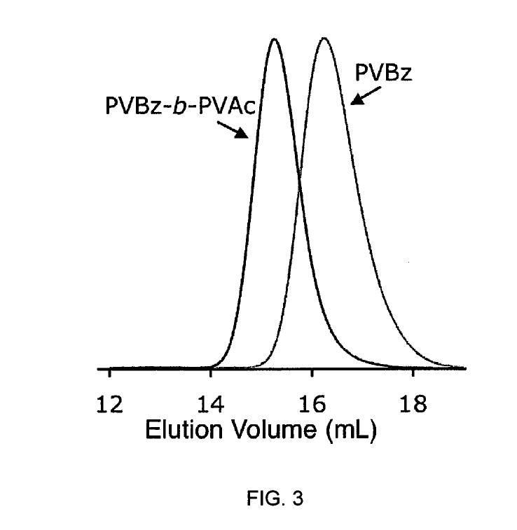

With small modifications, PVBz-b-PVAc copolymers were also prepared by starting from a PVBz-RAFT macro RAFT agent, using a protocol similar to the one described to produce the PVBz-RAFT macro RAFT agent and reacting with vinyl acetate monomers. An SEC trace comparing the PVBz-b-PVAc copolymer to the PVBz-RAFT macro RAFT agent can be seen in FIG. 3.

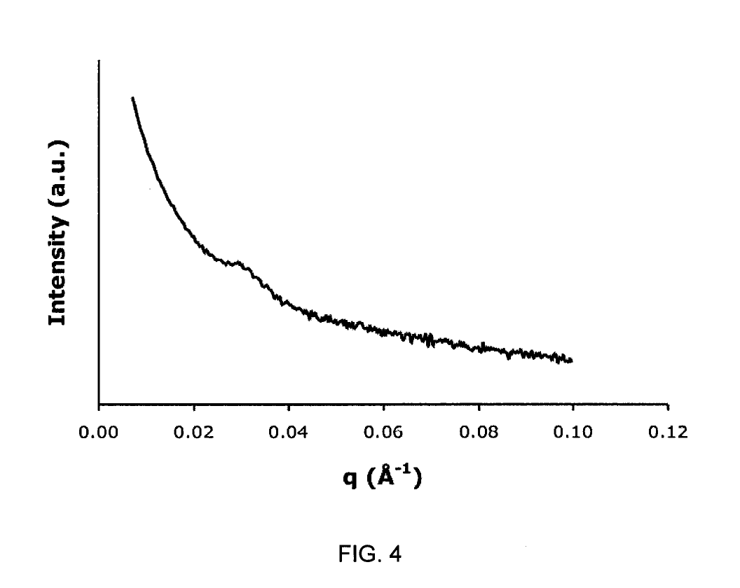

The morphology of the resultant PVBz-b-PVAc copolymers were determined by small-angle X-ray scattering (SAXS) measurements in a temperature-controlled stage (described in Example 1). A SAXS measurement of the PVBz-b-PVAc copolymer at 160° C. is shown in FIG. 4. The lack of structure in FIG. 4 indicates that the PVBz-b-PVAc copolymer is melt disordered and does not adopt a microphase separated state at 160° C. The single broad peak at approximately 0.03 Å⁻¹ corresponds results from correlation hole scattering characteristic of a disordered diblock copolymer melt.

### Example 3

### Synthesis of PVBz-b-PVPv copolymer with Reversible Addition-Fragmentation Chain Transfer Polymerization

Synthesis of PVBz-RAFT macro RAFT agent: Analogous to the protocol described in Example 1, Ethyl 2-(ethoxycarbonothioylthio)propanoate (125.8 mg, 0.57 mmol) (synthesized in Example 1) and 2,2′-Azobis(isobutyronitrile) (AIBN, Sigma-Aldrich) (13.6 mg, 0.08 mmol) were dissolved in 25.3 mL (159.1 mmol) of vinyl benzoate (VBz) (Sigma-Aldrich), which had been distilled under full vacuum from calcium hydride and subsequently AIBN immediately prior to use. This solution was degassed by three freeze-pump-thaw cycles, and sealed under vacuum. To initiate reaction, the reaction mixture was immersed in a 75° C. oil bath and reaction was run for 3.5 hours. Reaction mixture was then removed from the oil bath, and cooled under running water to terminate the polymerization. The resulting PVBz-RAFT macro RAFT agent was then isolated by precipitation in 400 mL of hexanes (Sigma-Aldrich). In order to remove any traces of VBz monomer from the PVBz-RAFT macro RAFT agent, the solids were dissolved in benzene (Sigma-Aldrich) and freeze-dried in vacuum at room temperature. Similar to Example 1, absolute molecular weight determination by size exclusion chromatography with light scattering using a refractive index increment do/dc=0.131 L/g at 30° C. in THF demonstrates that the molecular weight of this polymer was Mₙ=7.1 kg/mol with M_{w}/Mₙ=1.42 (against poly(styrene) standards in THF at 30° C.).

Synthesis of PVBz-b-PVPv copolymer: PVBz-RAFT macro RAFT agent (0.19 g, 0.03 mmol) (synthesized above) and AIBN (5 mg) were dissolved in vinyl pivalate (VPv) (7.7 mL, 51.8 mmol) (Sigma-Aldrich), which had been stirred over basic alumina for 20 minutes and filtered immediately prior to use, and co-solvent benzene (8 mL, Sigma-Aldrich). The mixture was degassed by three freeze-pump-thaw cycles, sealed under vacuum, and heated to 60° C. After 4.5 hours, the reaction was removed from the heating bath, and cooled under running water and exposed to air to terminate the polymerization reaction. Residual vinyl benzoate monomer was removed from the reaction solution by rotary evaporation. The resulting polymer was then freeze dried from benzene in vacuum at 22° C. The number average molecular weight of the resultant PVBz-b-PVPv copolymer was Mₙ=14.8 kDa, and the polydispersity of the resultant PVBz-b-PVPv copolymer was M_{w}/Mₙ=1.85 (against polystyrene standards in THF at 30° C.).

Similar to Example 1, the resultant PVBz-b-PVPv copolymer and the PVBz-RAFT macro RAFT agent were sequentially analyzed by size exclusion chromatography (SEC) (Viscotek GPCMax System, described above). Tetrahydrofuran (THF) was used as the mobile phase at 30° C. with a flow rate of 1.0 mL/min. This analysis demonstrates that both polymers are unimodal and that there is a clear reduction in the elution volume associated with the block copolymer as compared to the macro RAFT agent, indicative of its higher molecular weight.

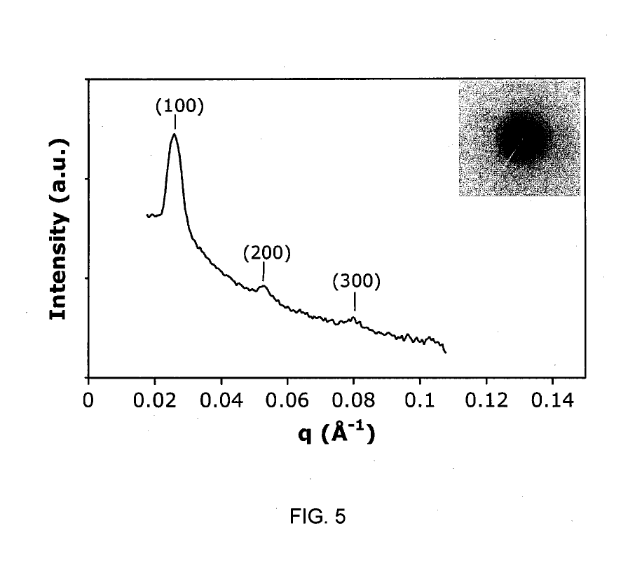

The morphology of the resultant PVBz-b-PVPv copolymers were determined by taking small-angle X-ray scattering (SAXS) measurements in a temperature-controlled stage (described in Example 1). A SAXS measurement of the PVBz-b-PVPv copolymer at 160° C. is shown in FIG. 5. The peaks in FIG. 5 are indicative of the PVBz-b-PVPv copolymer having a lamellar morphology with a q*=0.0268 Å⁻¹.

TABLE 1
Poly(vinyl ester) block copolymers synthesized by sequential RAFT
Polymerization as described in EXAMPLES 1-3.

| | Initial Block | | Block Copolymer | | | |
|---|---|---|---|---|---|---|
| | Mₙ | | M_{n,total} | | | |
| | (kg/ | M_{w}/ | (kg/ | M_{w}/ | mol | |
| Copolymer | mol)^{a} | Mₙ^{b} | mol)^{c} | Mₙ^{b} | fraction^{c} | Morphology^{d} |
| PVAc-b- | 5.0 | 1.25 | 24.9 | 1.33 | 0.704 | dis |
| PVBz | (60° C., | | (80° C., | | | |
| | AIBN) | | AIBN) | | | |
| PVBz-b- | 11.3 | 1.39 | 17.1 | 1.34 | 0.471 | dis |
| PVAc | (75° C., | | (60° C., | | | |
| | AIBN) | | AIBN) | | | |
| PVPv-b- | 14.8 | 1.28 | 24.8 | 1.33 | 0.504 | Hexagonal |
| PVAc-1 | (60° C., | | (60° C., | | | |
| | AIBN) | | AIBN) | | | |
| PVAc-b- | 5.6 | 1.24 | 14.9 | 1.23 | 0.538 | dis |
| PVPv | (60° C., | | (60° C., | | | |
| | AIBN) | | AIBN) | | | |
| PVBz-b- | 7.1 | 1.42 | 14.8^{e} | 1.85 | 0.565 | Lamellar |
| PVPv | (75° C., | | (60° C., | | | |
| | AIBN) | | AIBN) | | | |

^{a}Absolute Mₙ from SEC analysis with light scattering detection, with reaction temperature and initiator listed in parentheses.
^{b}Determined using SEC calibrated using polystyrene standards.
^{c}M_{n,total} was calculated using the molar composition the block copolymer determined by quantitative ¹H NMR in conjunction with the Mₙ of the initial block; the reaction temperature and initiator are listed in parentheses, and [macro-RAFT] = 2-19 mM in bulk monomer.
^{d}Determined by SAXS at 160° C.
^{e}Benzene co-solvent was added so that [VBz]₀ = 3.3M.

### Example 4

### Multiblock Copolymer Synthesis Using Reversible Addition-Fragmentation Chain Transfer Polymerization

Synthesis of telechelic α,ω-bis(xanthyl)poly(vinyl acetate) macro-RAFT agent: Difunctional RAFT chain transfer agent (DRCTA-1, below) was synthesized according to the methods disclosed in Taton et al., “Direct synthesis of double hydrophilic statistical di- and triblock copolymers comprised of acrylamide and acrylic acid units via the MADIX process.” Macromolecular Rapid Communications (2001) vol. 22, 1497-1503, incorporated herein by reference in its entirety.

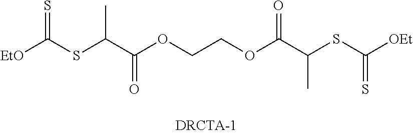

After synthesis and purification, DRCTA-1 (0.42 g, 1.00 mmol) and AIBN (33.5 mg, 0.204 mmol) were dissolved in 40 mL VAc. This mixture was degassed by three freeze-pump-thaw cycles and heated to 60° C. in an oil bath. After 3.3 h, the reaction mixture was cooled to room temperature under cold running water and diluted with THF (20 mL). The reaction was approximately 50% efficient. The resulting telechelic α,ω-bis(xanthyl)poly(vinyl acetate) macro-RAFT agent was precipitated into hexanes (500 mL), and then freeze-dried from benzene to produce the purified poly(vinyl acetate) macro RAFT chain transfer agent shown below:

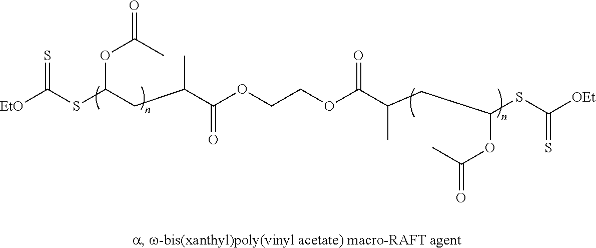

SEC analysis of the α,ω-bis(xanthyl)poly(vinyl acetate) macro-RAFT agent was performed using a Viscotek GPCMax System equipped with two Polymer Labs Resipore columns (250 mm×4.6 mm), and four detectors manufactured by Viscotek including a differential refractometer, two angle-light scattering module (7° and 90°), a four-capillary differential viscometer, and UV/Vis detector (Malvern Instruments, Ltd., Malvern, England). Tetrahydrofuran (THF) was used as the eluent at 30° C. with a flow rate of 1.0 mL/min. As in EXAMPLE 2, a conventional calibration curve was constructed based on 10 narrow molecular weight distribution polystyrene standards with Mₙ=580-377400 Da which was Mark-Houwink corrected for PVAc molecular weights. Size exclusion chromatography of the telechelic α,ω-bis(xanthyl)poly(vinyl acetate) macro-RAFT agent showed that Mₙ=19.1 kg/mol and M_{w}/Mₙ=1.23. Additionally, ¹H NMR spectra of the α,ω-bis(xanthyl)poly(vinyl acetate) macro-RAFT agent were recorded in CDCl₃ on a Varian Unity Inova 500 spectrometer and were referenced relative to the residual protiated solvent peaks in the sample. Using endgroup analyses at 500 MHz, number average molecular weights (Mₙ) of the α,ω-bis(xanthyl)poly(vinyl acetate) macro-RAFT were within ±5% of the SEC results.

Several α,ω-bis(xanthyl)poly(vinyl acetate) macro-RAFT agents bearing xanthate endgroups with different molecular weights were synthesized by varying the reaction times, and therefore the monomer conversions. Using SEC and NMR the α,ω-bis(xanthyl)poly(vinyl acetate) macro-RAFT agents were characterized, as shown in Table 2.

TABLE 2
Characterization of telechelic α,ω-bis(xanthyl)poly(vinyl
acetate) macro-RAFT chain transfer agents (CTAs) with
varying polymer lengths.

| Macro-RAFT | Mₙ, _{SEC} | | |
|---|---|---|---|
| CTA | (kg/mol) | M_{w}/Mₙ | DP |
| a | 2.3 | 1.29 | 11.0 |
| b | 5.5 | 1.19 | 29.5 |
| c | 5.7 | 1.20 | 30.7 |
| d | 9.5 | 1.18 | 52.8 |
| e | 10.8 | 1.17 | 60.3 |
| f | 11.3 | 1.15 | 63.2 |
| g | 11.7 | 1.19 | 65.5 |
| h | 13.6 | 1.20 | 76.6 |
| i | 15.2 | 1.15 | 85.9 |
| j | 19.1 | 1.23 | 108.5 |
| k | 20.2 | 1.17 | 114.9 |
| l | 22.8 | 1.18 | 130.2 |

Bidirectional synthesis of poly(vinyl benzoate-block-vinyl acetate-block-vinyl benzoate) (BAB-3): Macro-RAFT agent j of TABLE 2 (2.04 g, 0.11 mmol, Mₙ=19.1 kg/mol), vinyl benzoate (VBz) (15 mL, 0.11 mol), 1,1′-azobis(cyclohexane-1-carbonitrile) (5.5 mg, 0.021 mmol; V40™, Wako Chemicals, Richmond, Va.) were combined to yield a solution of [Macro-RAFT j]=14.26 mM and [Macro-RAFT j]:[V-40]=1:0.22. The reaction was degassed via three freeze-pump-thaw cycles and heated in a 88° C. oil bath. After 3.5 h, the polymerization reaction mixture was cooled to room temperature under cold running water. The resulting polymer solution was diluted with THF (20 mL) and precipitated in 500 mL of hexanes. The recovered poly(vinyl benzoate-block-vinyl acetate-block-vinyl benzoate) copolymer was dissolved in 30 mL of benzene and then precipitated in 500 mL of hexanes. The resulting solid was next purified by freeze-drying from benzene. Using size exclusion chromatography, the multiblock copolymer was determined to have M_{n, NMR}=48.4 kg/mol (based on composition analysis by ¹H NMR), M_{w}/Mₙ=1.53 (against PS Standards).

In a similar fashion, a number of PVBz-b-PVAc-b-PVBz triblock copolymers with different molecular weights and comonomer compositions were synthesized by analogous protocols using Macro-RAFT CTAs of varying molecular weights and by varying the reaction times to achieve the desired level of monomer conversion. SEC analyses of the triblock copolymers were performed using the above system and polydispersity indices M_{w}/Mₙ were determined based on the polystyrene calibration curve discussed above. The resultant PVBz-b-PVAc-b-PVBz (BAB) triblock copolymers are listed in Table 3.

TABLE 3
Characteristics of PVBz-b-PVAc-
b-PVBz (BAB) Triblock Copolymers

| | | M_{n, NMR} | | | |
|---|---|---|---|---|---|
| | Macro- | (kg/mol) | Total | | |
| | RAFT | VBz | M_{n, NMR} | | Morphology at |
| Sample | CTA | blocks^{a} | (kg/mol)^{a} | M_{w}/Mₙ^{b} | 152° C.^{c} |
| BAB-1 | e | 17.5 | 35.1 | 1.46 | Disordered |
| BAB-2 | i | 13.4 | 41.7 | 1.45 | Disordered |
| BAB-3 | j | 14.7 | 48.4 | 1.53 | Hexagonal |
| BAB-4 | j | 16 | 51.0 | 1.57 | Disordered |
| BAB-5 | i | 18.3 | 51.8 | 1.37 | Disordered |

^{a}Determined by quantitative ¹H NMR of the triblock copolymer using the molecular weight of the initial Macro-RAFT CTA from Table 1.
^{b}Determined using SEC at 30° C. in THF using a polystyrene calibration curve.
^{c}Determined by temperature-dependent small-angle X-ray scattering.

Small Angle X-ray Scattering (SAXS) measurements were performed on the VBz-b-VAc-b-VBz triblock copolymers at the Materials Science Center at the University of Wisconsin—Madison. Cu K_{α} X-rays generated by a microfocus source (MicroMax™ 002+, Rigaku Americas, The Woodlands, Tex.) collimated using a multi-layer confocal optic (MaxFlux™, Rigaku Americas) followed by passage through three collimating pinholes to reduce the final beam diameter to less than 0.5 mm. Samples were mounted in a vacuum chamber and heated using a hot stage (Linkam) with a 10 min equilibration time (typical exposure times ˜10 min). A 75 mm diameter active area x-ray detector was used to record 2D-SAXS patterns at a sample to detector distance of 2.015 m. Morphology data for the PVBz-b-PVAc-b-PVBz triblock copolymers is shown in TABLE 3.

Bidirectional synthesis of poly(vinyl pivalate-block-vinyl acetate-block-vinyl pivalate) (PAP-11): Macro-RAFT agent h of TABLE 2 (1.04 g, 0.08 mmol, Mₙ=13.6 kg/mol), vinyl pivalate (VPv) monomer (9.00 mL, 0.06 mol), benzene (5.80 mL, 0.07 mol), and 0.20 mL of AIBN solution (11.9 M in C₆H₆) were combined in a 100 mL Schlenk tube to yield a solution of [h]=5.1 mM and [2h]:[AIBN]=1:0.20. The reaction was degassed via three freeze-pump-thaw cycles and heated in a 60° C. oil bath. After 6.6 h, the polymerization reaction was cooled to room temperature under cold running water. The resulting PVPv-b-PVAc-b-PVPv copolymer was diluted with THF (20 mL) and co-evaporated under reduced pressure to remove the VPv monomer and solvent. The resulting solid was freeze-dried from benzene and characterized with ¹H NMR, SEC and SAXS. Calculated M_{n, NMR}=52.6 kg/mol, M_{w}/Mₙ=1.32 (from SEC against PS Standards).

Numerous PVPv-b-PVAc-b-PVPv (PAP) triblock copolymers with different molecular weights and comonomer compositions were synthesized by analogous protocols using Macro-RAFT CTAs of varying molecular weights and by varying the reaction times to achieve the desired level of monomer conversion. The various PVPv-b-PVAc-b-PVPv (PAP) triblock copolymers are shown in Table 4.

TABLE 4
Characterization Data for PVPv-b-
PVAc-b-PVPv triblock copolymers.

| | | M_{n, NMR} | | | |
|---|---|---|---|---|---|
| | Macro- | (kg/mol) | Total | | |
| | RAFT | VPv | M_{n, NMR} | | Morphology at |
| Sample | CTA | blocks^{a} | (kg/mol)^{a} | M_{w}/Mₙ^{b} | 152° C.^{c} |
| PAP-1 | a | 2.4 | 7.1 | 1.32 | n.d.^{d} |
| PAP-2 | c | 1.3 | 8.4 | 1.32 | n.d.^{d} |
| PAP-3 | g | 3.4 | 18.6 | 1.18 | Disordered |
| PAP-4 | l | 3.6 | 29.7 | 1.30 | Hexagonal |
| PAP-5 | d | 12.8 | 35.1 | 1.28 | Hexagonal |
| PAP-6 | k | 7.5 | 35.2 | 1.24 | Lamellar |
| PAP-7 | g | 11.9 | 35.5 | 1.33 | Hexagonal |
| PAP-8 | b | 16.8 | 39.1 | 1.30 | Disordered |
| PAP-9 | e | 18.1 | 47.1 | 1.32 | Hexagonal |
| PAP-10 | f | 18.5 | 48.3 | 1.30 | Hexagonal |
| PAP-11 | h | 19.5 | 52.5 | 1.34 | Hexagonal |

^{a}Determined by quantitative ¹H NMR of the triblock copolymer using the molecular weight of the initial Macro-RAFT CTA from Table 1.
^{b}Determined using SEC at 30° C. in THF using a polystyrene calibration curve.
^{c}Determined by temperature-dependent small-angle X-ray scattering.
^{d}not determined.

### Example 5

### Synthesis of PVAc-b-PVPv Copolymer with poly(vinyl ester) Diblock Copolymers of the Invention by Cobalt-Mediated Radical Polymerization (CMRP)

Cobalt(II) acetylacetonate hydrate [Co(acac)₂.2H₂O], Alfa Aesar, Ward Hill, Mass.] was recrystallized twice from acetone in order to dehydrate the complex followed by scrupulous drying under vacuum to form cobalt(II) acetylacetonate [Co(acac)₂]. The dehydrated Co(acac)₂ (115.3 mg, 0.448 mmol) was then combined with LUPEROX™ (137 mg, 0.345 mmol; (LUPEROX™, Arkema Inc., Philadelphia, Pa.) as an organic peroxide initiator under nitrogen. In a separate flask, a suspension of freshly distilled vinyl acetate (VAc) (7.9 mL, 85.7 mmol) and citric acid (71.4 mg, 0.372 mmol) (Sigma-Aldrich) was prepared and degassed by three freeze-pump-thaw cycles. Under a flush of nitrogen, the citric acid/vinyl acetate slurry was added to the Co(acac)₂ and organic peroxide mixture. The reaction mixture was heated to 30° C. to start the polymerization reaction. After 4.3 h, the VAc polymerization was stopped by removal from the heating bath and cooling under nitrogen. The product was isolated by removal of the excess VAc under vacuum to yield a solid. Size exclusion chromatography analysis using a Mark-Houwink corrected polystyrene calibration curve (described above) shows that this polymer has Mₙ=19.3 kg/mol and M_{w}/Mₙ=1.35.

The resulting cobalt end-capped PVAc polymer was redissolved (under nitrogen) in degassed, freshly distilled vinyl pivalate (VPv, 12.6 mL, 87.1 mmol) and the reaction was re-heated to 30° C. for 1.45 h to produce a cobalt end-capped PVAc-b-PVPv diblock copolymer. The polymerization was cooled to room temperature, stirred with 2,2,6,6-tetramethylpiperidine-N-oxyl (TEMPO, Sigma Aldrich) (138 mg, 0.885 mmol) in 17 mL THF (Sigma Aldrich), and exposed to air. The resulting copolymer was then dissolved in methanol and evaporated to dryness to yield a solid PVAc-b-PVPv copolymer sample. Using SEC, the polydispersity of the resultant PVAc-b-PVPv copolymer was determined to be M_{w}/Mₙ=1.32 (against polystyrene standards in THF at 30° C.). ¹H NMR analysis shows that this polymer contains 80.8 mol % VPv and the polymer has a total Mₙ=141 kg/mol (calculated from the Mₙ of the cobalt end-capped PVAc and the composition from ¹H NMR). SAXS analysis of the PVAc-b-PVPv copolymer at 150° C. indicated that the PVAc-b-PVPv copolymer microphase separated into a spheres morphology.

### Example 6

### Synthesis of PVAc-b-PVBz Copolymer with Cobalt-Mediated Radical Polymerization

Cobalt(II) acetylacetonate hydrate [Co(acac)₂.2H₂O, Alfa Aesar, Ward Hill, Mass.] was recrystallized twice from acetone in order to dehydrate the complex followed by scrupulous drying under vacuum to form cobalt(II) acetylacetonate [Co(acac)₂]. The dehydrated Co(acac)₂ (113.8 mg, 0.442 mmol) was then combined with LUPEROX™ (136 mg, 0.341 mmol; (LUPEROX™, Arkema Inc., Philadelphia, Pa.) as an organic peroxide initiator under nitrogen. In a separate flask, a suspension of freshly distilled vinyl acetate (VAc) (7.9 mL, 85.7 mmol) and citric acid (65.3 mg, 0.340 mmol) (Sigma-Aldrich) was prepared and degassed by three freeze-pump-thaw cycles. Under a flush of nitrogen, the citric acid/vinyl acetate slurry was added to the Co(acac)₂ and organic peroxide initiator mixture. The reaction was then heated to 30° C. to initiate the polymerization. After 5.8 h, the VAc polymerization was stopped by removal from the heating bath and cooling under nitrogen. The product was isolated by removal of the excess VAc under vacuum to yield a solid. Size exclusion chromatography analysis using a Mark-Houwink corrected polystyrene calibration curve (described above) shows that this polymer has Mₙ=8.7 kg/mol and M_{w}/Mₙ=1.21.

The resulting cobalt end-capped PVAc polymer was redissolved (under nitrogen) in degassed, freshly distilled vinyl benzoate (VBz, 10.3 mL, 74.4 mmol) and the reaction was re-heated to 30° C. for 11.8 h to produce a cobalt end-capped PVAc-b-PVBz diblock copolymer. The polymerization was cooled to room temperature, stirred with 2,2,6,6-tetramethylpiperidine-N-oxyl (TEMPO, Sigma Aldrich) (18.1 mg, 0.116 mmol) in 17 mL THF (Sigma Aldrich), and exposed to air. The resulting copolymer was then precipitated in 300 mL cold hexanes to yield a solid PVAc-PVBz copolymer sample. Using SEC, the polydispersity of the resultant PVAc-PVBz copolymer was determined to be M_{w}/Mₙ=1.74 (against polystyrene standards in THF at 30° C.). ¹H NMR analysis shows that this polymer contains 51.1 mol % VBz and the polymer has a total Mₙ=24.4 kg/mol (calculated from the Mₙ of the cobalt end-capped PVAc and the composition from ¹H NMR). SAXS analysis of the PVAc-b-PVBz copolymer at 150° C. indicated that the PVAc-b-PVPv copolymer does not microphase separate as evidenced by the observation of only correlation hole scattering. Variation of the reaction times may produce block copolymers of sufficiently high molecular weights to form microphase separated morphologies.

### Prophetic Examples

### Example 7

### Synthesis of PVAc-b-PVPv-b-PVBz Multiblock Copolymer with Cobalt-Mediated Radical Polymerization

Using the method of EXAMPLE 5, a cobalt end-capped PVAc-b-PVPv copolymer will be prepared. The resulting cobalt end-capped PVAc-b-PVPv copolymer will be redissolved under nitrogen in degassed vinyl benzoate (VBz) and the reaction re-heated to 30° C. for 8 h to produce a PVAc-b-PVPv-b-PVBz triblock copolymer. The polymerization will be cooled to room temperature and exposed to air. The resulting copolymer will then be isolated by vacuum drying to yield a solid PVAc-b-PVPv-b-PVBz copolymer sample. Using SEC, the polydispersity of the resultant PVAc-b-PVPv-b-PVBz multiblock copolymer will be determined. The PVAc-b-PVPv-b-PVBz multiblock copolymer will also be analyzed with SAXS to determine the microphase separated morphology.

### Example 8

### Synthesis of PVAc-b-PBz copolymer with Organobismuthine Living Radical Polymerization

Thoroughly deoxygenated vinyl acetate (VAc, 10 g, 112 mmol), freshly distilled from NaBH₄ prior to use, will be combined with methyl 2-(dimethylbismuthanyl) isobutyrate (76.2 mg, 0.224 mmol) and AIBN (7.4 mg, 0.045 mmol) under a nitrogen atmosphere. This mixture will be heated to 60° C. for 4 hours. The reaction will then be cooled and the excess VAc monomer will be completely removed under vacuum to yield a bismuth end-capped PVAc homopolymer.

The bismuth end-capped PVAc will be redissolved in vinyl benzoate (VBz, 20 g, 135 mmol), freshly distilled from NaBH₄ prior to use, and this mixture will be heated to 60° C. under nitrogen for 8 h to yield a bismuth end-capped PVAc-b-PBz block copolymer. The reaction solution will be poured in 600 mL cold hexanes to precipitate the polymer followed by isolation by vacuum filtration. Vacuum drying the solids will yield a solid PVAc-b-PBz copolymer sample. Using SEC, the polydispersity of the resultant PVAc-b-PBz diblock copolymer will be determined. The PVAc-b-PBz diblock copolymer will also be analyzed with SAXS to determine the microphase separated morphology.

Thus, the invention provides, among other things, poly(vinyl ester) block copolymers and methods of making poly(vinyl ester) block copolymers. Various features and advantages of the invention are set forth in the following claims.

1. A vinyl ester multiblock copolymer comprising three blocks of two different vinyl ester repeating units.

2. The vinyl ester multiblock copolymer of claim 1, comprising vinyl ester repeating units of 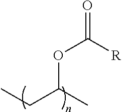
wherein R is H, C₁-C₂₂ straight or branched alkyl or alkylhalide, or phenyl or substituted phenyl, and n is 10 to 12,000.

3. The vinyl ester multiblock copolymer of claim 2, wherein the vinyl ester repeating units are selected from the group consisting of vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

4. The vinyl ester multiblock copolymer of claim 2, wherein the phenyl group of the vinyl benzoate repeating units are substituted with halo, hydroxy, or amino.

5. The vinyl ester multiblock copolymer of claim 1, wherein the multiblock copolymer comprises four blocks of two different vinyl ester repeating units.

6. The vinyl ester multiblock copolymer of claim 5, wherein the multiblock copolymer comprises five blocks of two different vinyl ester repeating units.

7. The vinyl ester multiblock copolymer of claim 1, wherein the multiblock copolymer comprises three blocks of three different vinyl ester repeating units.

8. The vinyl ester multiblock copolymer of claim 7, wherein the multiblock copolymer comprises four blocks of three different vinyl ester repeating units.

9. The vinyl ester multiblock copolymer of claim 7, wherein the multiblock copolymer comprises five blocks of three different vinyl ester repeating units.

10. The vinyl ester multiblock copolymer of claim 1, wherein the copolymer is linear.

11. The vinyl ester multiblock copolymer of claim 1, wherein the copolymer is branched.

12. A vinyl ester diblock copolymer comprising repeating units selected from the group consisting of vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

13. The vinyl ester diblock copolymer of claim 12, additionally comprising repeating units of 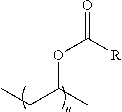
wherein R is H, C₁-C₂₂ straight or branched alkyl or alkylhalide, or phenyl or substituted phenyl, and n is 10 to 12,000.

14. The vinyl ester diblock copolymer of claim 12, additionally comprising vinyl acetate (VAc) or vinyl pivalate (VPv).

15. A method of making a vinyl ester block copolymer comprising:
contacting a vinyl ester monomer with 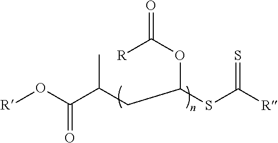
wherein R is H, C₁-C₂₂ straight or branched alkyl or alkylhalide, or phenyl or substituted phenyl, R′ is C₁-C₆ branched or straight-chain alkane, R″ is C₁-C₄ alkoxy, phenoxy or substituted phenoxy, or NR₂′″ wherein R′″ is phenyl or substituted phenyl, and n is 10 to 12,000; and
forming a vinyl ester block copolymer.

16. The method of claim 15, wherein R is phenyl, t-butyl, or methyl.

17. The method of claim 15, wherein R′ is ethyl.

18. The method of claim 15, wherein R″ is ethoxy, N,N-diphenylamino, (4-methoxyphenyl)oxy, or 4-fluorophenoxy.

19. The method of claim 15, wherein the vinyl ester monomer is selected from the group consisting of vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

20. A method of making a vinyl ester multiblock copolymer comprising
contacting a vinyl ester monomer with 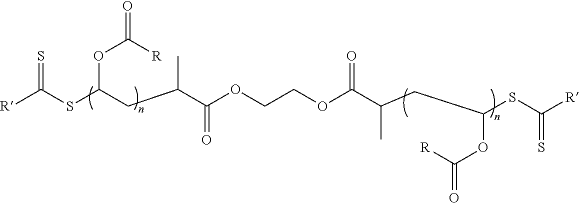
wherein R is H, C₁-C₂₂ straight or branched alkyl or alkylhalide, or phenyl or substituted phenyl, R′ is C₁-C₄ alkoxy, phenoxy or substituted phenoxy, or NR₂″ wherein R″ is phenyl or substituted phenyl, and n is 10 to 12,000; and
forming a vinyl ester multiblock copolymer.

21. The method of claim 20, wherein R is phenyl, t-butyl, or methyl.

22. The method of claim 20, wherein R′ is ethoxy, N,N-diphenylamino, (4-methoxyphenyl)oxy, or 4-fluorophenoxy.

23. The method of claim 20, wherein the vinyl ester monomer is selected from the group consisting of vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

24. A method of making a vinyl ester-block-vinyl benzoate copolymer comprising:
contacting vinyl ester monomers with cobalt(II) acetylacetonate, an organic peroxide, an inorganic peroxide, or an organic diazo compound, and a reducing agent to make a vinyl ester monomer mixture;
heating the vinyl ester monomer mixture to make a cobalt end-capped vinyl ester polymer;
cooling the cobalt end-capped vinyl ester polymer;
contacting the cobalt-end capped vinyl ester polymer with vinyl benzoate monomer to make a cobalt end-capped vinyl ester polymer-vinyl benzoate monomer mixture; and
heating the cobalt end-capped vinyl ester polymer-vinyl benzoate monomer mixture to make a cobalt end-capped vinyl ester-block-vinyl benzoate copolymer.

25. The method of claim 24, wherein the vinyl ester monomers are selected from the group consisting of vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

26. The method of claim 24, wherein the reducing agent comprises citric acid.

27. A method of making a vinyl ester multiblock copolymer comprising:
contacting first vinyl ester monomers with cobalt(II) acetylacetonate, an organic peroxide, an inorganic peroxide, or an organic diazo compound, and a reducing agent to make a first vinyl ester monomer mixture;
heating the first vinyl ester monomer mixture to make a cobalt end-capped first vinyl ester polymer;
cooling the cobalt end-capped first vinyl ester polymer;
contacting the cobalt end-capped first vinyl ester polymer with second vinyl ester monomers to make a cobalt end-capped first vinyl ester polymer-second vinyl ester monomer mixture;
heating the cobalt end-capped first vinyl ester polymer-second vinyl ester monomer mixture to make a cobalt end-capped first vinyl ester-block-second vinyl ester copolymer;
cooling the cobalt end-capped first vinyl ester-block-second vinyl ester copolymer;
contacting the cobalt end-capped first vinyl ester-block-second vinyl ester copolymer with third vinyl ester monomers to make a cobalt end-capped first vinyl ester-block-second vinyl ester copolymer-third vinyl ester monomer mixture; and
heating the cobalt end-capped first vinyl ester-block-second vinyl ester copolymer-third vinyl ester monomer mixture to make a vinyl ester multiblock copolymer.

28. The method of claim 27, wherein the first, second, and third vinyl ester monomers are selected from the group consisting of vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

29. The method of claim 27, wherein the first vinyl ester monomers and the third vinyl ester monomers are the same.

30. The method of claim 27, wherein the reducing agent comprises citric acid.

31. A method of making a vinyl ester block copolymer comprising:
contacting first vinyl ester monomers with an organobismuthine and an organic peroxide, an inorganic peroxide, or an organic diazo compound to make a first vinyl ester monomer mixture;
heating the first vinyl ester monomer mixture to make a bismuth end-capped first vinyl ester polymer;
cooling the bismuth end-capped first vinyl ester polymer;
contacting the bismuth end-capped first vinyl ester polymer with second vinyl ester monomers to make a bismuth end-capped first vinyl ester polymer-second vinyl ester monomer mixture; and
heating the bismuth end-capped first vinyl ester polymer-second vinyl ester monomer mixture to make a first vinyl ester-block-second vinyl ester block copolymer.

32. The method of claim 31, wherein the first and second vinyl ester monomers are selected from the group consisting of vinyl acetate (VAc), vinyl pivalate (VPv), vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.

33. A method of making a multiblock copolymer selected from the group consisting of Reversible-Addition Fragmentation chain Transfer (RAFT), organobismuthine-mediated living radical polymerization, and cobalt mediated radical polymerization;
wherein the multiblock copolymer comprises a first and second block of repeating vinyl ester units, and
wherein the Reversible-Addition Fragmentation chain Transfer (RAFT) method comprises contacting a vinyl ester monomer with 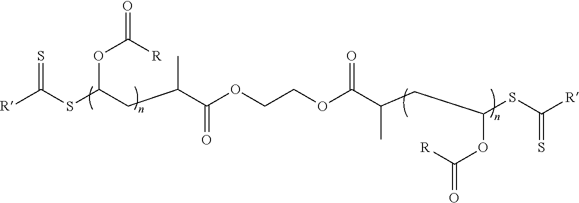
wherein R is H, C₁-C₂₂ straight or branched alkyl or alkylhalide, or phenyl or substituted phenyl, R′ is C₁-C₄ alkoxy, phenoxy or substituted phenoxy, or NR₂″ wherein R″ is phenyl or substituted phenyl, and n is 10 to 12,000, and forming a vinyl ester multiblock copolymer;
the organobismuthine-mediated living radical polymerization method comprises contacting first vinyl ester monomers with an organobismuthine and an organic peroxide, an inorganic peroxide, or an organic diazo compound to make a first vinyl ester monomer mixture, heating the first vinyl ester monomer mixture to make a bismuth end-capped first vinyl ester polymer, cooling the bismuth end-capped first vinyl ester polymer, contacting the bismuth end-capped first vinyl ester polymer with second vinyl ester monomers to make a bismuth end-capped first vinyl ester polymer-second vinyl ester monomer mixture, and heating the bismuth end-capped first vinyl ester polymer-second vinyl ester monomer mixture to make a bismuth end-capped first vinyl ester-block-second vinyl ester block copolymer, cooling the bismuth end-capped first vinyl ester-block-second vinyl ester copolymer, contacting the bismuth end-capped first vinyl ester-block-second vinyl ester copolymer with third vinyl ester monomers to make a bismuth end-capped first vinyl ester-block-second vinyl ester copolymer-third vinyl ester monomer mixture, and heating the bismuth end-capped first vinyl ester-block-second vinyl ester copolymer-third vinyl ester monomer mixture to make a vinyl ester multiblock copolymer; and
the cobalt mediated radical polymerization method comprises contacting first vinyl ester monomers with cobalt(II) acetylacetonate, an organic peroxide, an inorganic peroxide, or an organic diazo compound, and a reducing agent to make a first vinyl ester monomer mixture, heating the first vinyl ester monomer mixture to make a cobalt end-capped first vinyl ester polymer, cooling the cobalt end-capped first vinyl ester polymer, contacting the cobalt end-capped first vinyl ester polymer with second vinyl ester monomers to make a cobalt end-capped first vinyl ester polymer-second vinyl ester monomer mixture, heating the cobalt end-capped first vinyl ester polymer-second vinyl ester monomer mixture to make a cobalt end-capped first vinyl ester-block-second vinyl ester copolymer, cooling the cobalt end-capped first vinyl ester-block-second vinyl ester copolymer, contacting the cobalt end-capped first vinyl ester-block-second vinyl ester copolymer with third vinyl ester monomers to make a cobalt end-capped first vinyl ester-block-second vinyl ester copolymer-third vinyl ester monomer mixture, and heating the cobalt end-capped first vinyl ester-block-second vinyl ester copolymer-third vinyl ester monomer mixture to make a vinyl ester multiblock copolymer.

34. A degradable polymer comprising a vinyl ester multiblock copolymer comprising three blocks of two different vinyl ester repeating units.

35. A degradable polymer comprising a vinyl ester diblock copolymer comprising repeating units selected from the group consisting of vinyl benzoate (VBz), vinyl propionate (VPr), vinyl butyrate (VBut), vinyl stearate (VSt), vinyl chloroacetate (VClAc), vinyl dichloroacetate, vinyl trichloroacetate, vinyl fluoroacetate, vinyl trifluoroacetate, and vinyl 2-chloropropionate.
